(19) United States
(12) Patent Application Publication
(10) Pub. No.: US 2021/0104747 A1
(43) Pub. Date: Apr. 8, 2021

(54) ANTI-DENTRITE FUNCTIONAL SEPARATOR FOR SOLID STATE BATTERIES

(71) Applicant: TeraWatt Technology Inc., Santa Clara, CA (US)

(72) Inventors: Ken Ogata, Tokyo (JP); Yang Yang, Tokyo (JP); Hajime Hoshi, Tokyo (JP); Masatsugu Nakano, Tokyo (JP); Hiroshi Imoto, Tokyo (JP)

(73) Assignee: TeraWatt Technology Inc., Santa Clara, CA (US)

(21) Appl. No.: 16/596,696

(22) Filed: Oct. 8, 2019

(51) Int. Cl. H01M 4/62; H01M 10/0525; H01M 10/42; H01M 2/16

(52) U.S. Cl. CPC H01M 4/628; H01M 10/0525; H01M 2/1646; H01M 2/1686; H01M 10/4235

(57) ABSTRACT

A battery cell having a cathode, an anode, an electrolyte, and a dendrite absorber material. The dendrite absorber material reacts with lithium dendrite that forms on the anode after cycling the battery cell through charging and discharging cycles. The dendrite absorption material interacts with the lithium dendrite via lithium fusion. As a result of the lithium fusion, the dendrite absorber forms a lithium alloy and prevents expansion of the dendrite past the dendrite absorber material within the cell battery. This helps prevent short-circuiting between the anode and cathode due to lithium dendrite, which would cause performance degradation and safety issues such as fires.

### SUMMARY

The present technology, roughly described, includes a battery cell having a cathode, an anode, an electrolyte, and a dendrite absorber material. The dendrite absorber material reacts with lithium dendrite that forms on the anode after cycling the battery cell through charging and discharging cycles. The dendrite absorption material interacts with the lithium dendrite via lithium fusion. As a result of the lithium fusion, the dendrite absorber forms a lithium alloy and prevents expansion of the dendrite past the dendrite absorber material within the cell battery. This helps prevent short-circuiting between the anode and cathode due to lithium dendrite, which would cause performance degradation and safety issues such as fires.

In embodiments, a lithium-ion battery cell includes a casing, a cathode, an anode, an electrolyte, and a dendrite absorber material. The anode includes lithium ions, and the cathode and anode are within the casing. The electrolyte is between the anode and the cathode, and the dendrite lithium material forms on the anode due at least in part to lithium ion migration from the cathode to the anode. The dendrite absorber material is between the anode and the cathode as well. The dendrite absorber reacts with the dendrite lithium material that forms at the anode and extends toward the cathode. The reaction between the dendrite absorber and the dendrite lithium material reducing an extension of dendrite lithium material extending from the anode to the cathode.

### BRIEF DESCRIPTION OF FIGURES

FIG. 1 is a block diagram of a system powered by a lithium battery.

FIG. 2 is a block diagram of a battery cell having dendritic lithium growth.

FIG. 3 is a block diagram of a battery cell having dendritic lithium growth and a lithium absorber material.

FIG. 4 is a block diagram of a battery cell having dendritic lithium growth, a lithium absorber material, and lithium absorber alloy.

FIG. 5 is a method for limiting dendritic lithium growth using a lithium dendrite absorber.

FIG. 6 is a block diagram of a battery cell with a first lithium dendrite absorber and ceramic layer configuration within the battery cell.

FIG. 7 is a block diagram of a battery cell with a second lithium dendrite absorber and ceramic layer configuration within the battery cell.

FIG. 8 is a block diagram of a battery cell with a third lithium dendrite absorber and ceramic layer configuration within the battery cell.

FIG. 9 is a block diagram of a battery cell with a fourth lithium dendrite absorber and ceramic layer configuration within the battery cell.

### DETAILED DESCRIPTION

The present technology includes a battery cell having a cathode, an anode, an electrolyte, and a dendrite absorber material. The dendrite absorber material reacts with lithium dendrite that forms on the anode after cyling the battery cell through charging and discharging cycles. The dendrite absorption material interacts with the lithium dendrite via lithium fusion. As a result of the lithium fusion, the dendrite absorber forms a lithium alloy and prevents expansion of the dendrite past the dendrite absorber material within the cell battery. This helps prevent short-circuiting between the anode and cathode due to lithium dendrite, which would cause performance degradation and safety issues such as fires.

In operation, a lithium-ion migrates from the anode to the cathode through the battery cell electrolyte. The dendrite lithium deposits at the anode over time and multiple charge and discharge cycles. Over time, the dendrite lithium formation at the anode extends through the electrolyte towards the cathode. The dendrite growth reaches the dendrite absorber material, which can be placed within the battery cell electrolyte between the anode and the cathode. Lithium fusion occurs into the dendrite absorber material, and a lithium absorber alloy is formed.

In addition to implementing a dendrite absorber material, a ceramic separation layer may also be implemented within a battery cell. The configuration of the dendrite absorber material and the ceramic separation layer may vary. For example, the dendrite absorber material may be closer to the anode or cathode with respect to the ceramic separator material. In some instances, the dendrite absorber material and ceramic layer may alternate between an anode and cathode, wherein there are more than one of each of the dendrite absorber material and ceramic layer. Different implementations of a dendrite absorber material and ceramic layer are possible, and included within the scope of the present technology.

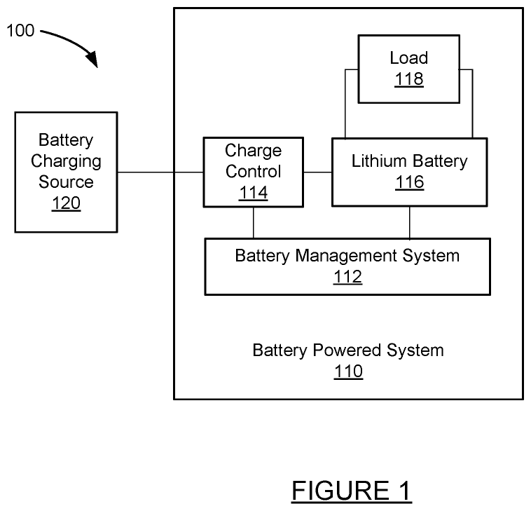

FIG. 1 is a block diagram of a system powered by a lithium battery. The system of FIG. 1 includes a battery-powered system 110 and a battery charging source 120. Battery-powered system 110 may include lithium battery 116, load 118, a charge control unit 114, and a battery management system (BMS) 112. Lithium battery 116 may be applied to load 118 within the battery-powered system 110. Battery-powered system may be one of several types of devices or systems, including but not limited to a mobile phone, smart phone, computing device, autonomous vehicle or electronic vehicle, or some other device or system.

Charge control 114 may receive a charge from battery charging source 120 and control how the charge is applied to lithium battery 116. Battery management system 112 may monitor lithium battery 116, and provide information to charge control 114 so that charging of the lithium battery can be performed as efficiently as possible in order to maintain the health of lithium battery 116.

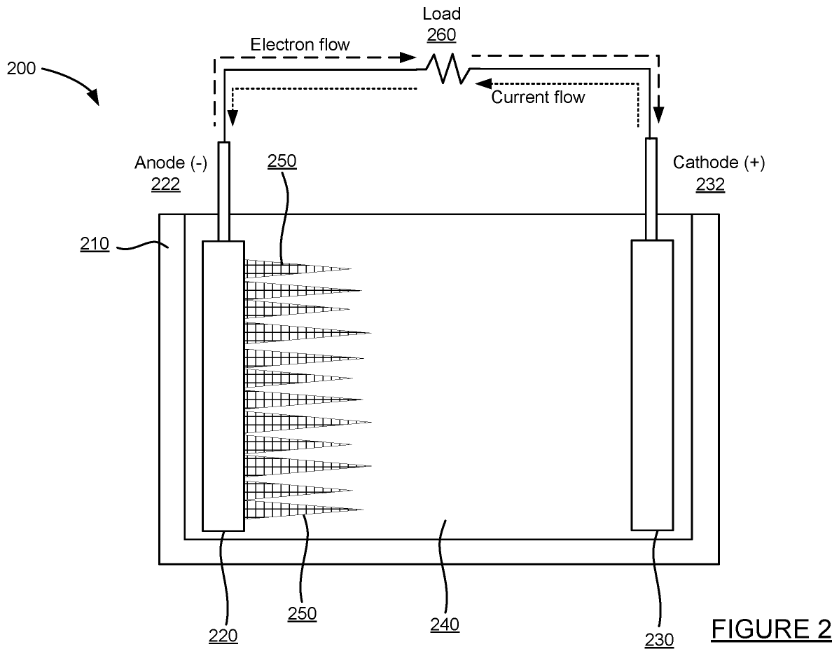

FIG. 2 is a block diagram of a battery cell having dendritic lithium growth. The battery cell of FIG. 2 includes battery case 210, and a 220, cathode 230, and electrolyte 240. During discharge, current flows through load 260 from the cathode to the anode. After multiple iterations charging and discharging, lithium deposition occurs at anode 222, and the thickness of the lithium deposition, or dendrite 250, increases. As shown, the dendrite 250 extends from anode 222 to cathode 230 over time.

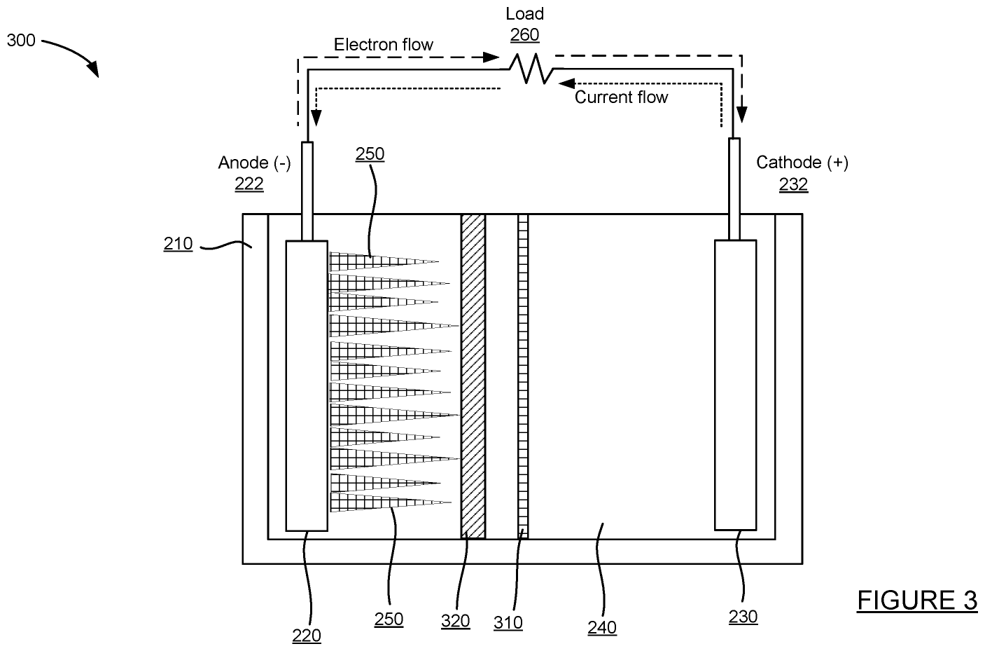

FIG. 3 is a block diagram of a battery cell having dendritic lithium growth and a lithium absorber material. To curb the growth of dendrite 250, a dendrite absorber material 320 can be placed in the electrolyte 240 between the anode and the cathode. In some instances, a ceramic layer 310 may also be placed between the anode and cathode. The dendrite absorber material helps to curb or limit the dendrite growth from the anode towards the cathode, thereby helping to prevent a short circuit between the anode and cathode and avoid an unsafe situation within the battery cell that may lead to fire.

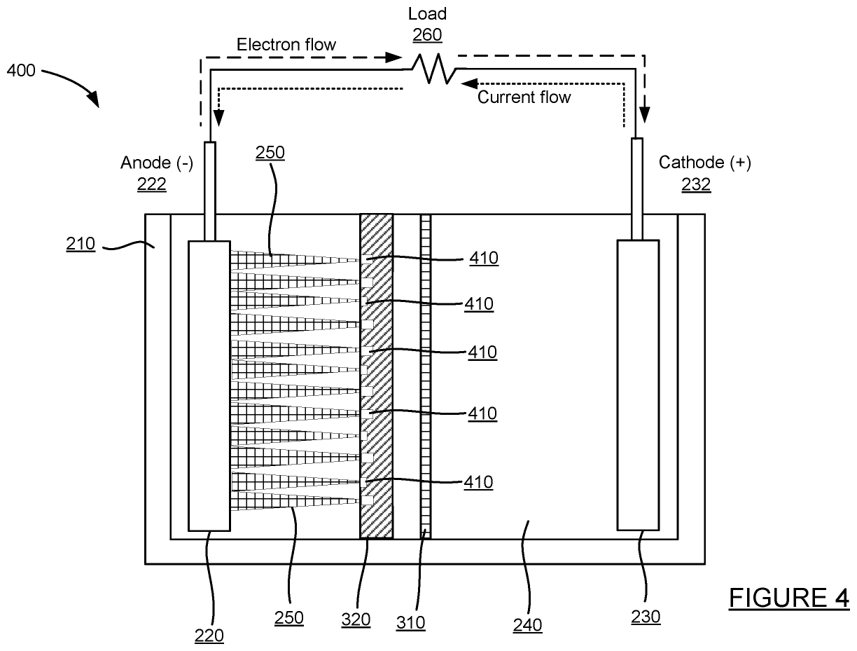

FIG. 4 is a block diagram of a battery cell having dendritic lithium growth, a lithium absorber material, and lithium absorber alloy. When the dendrite growth 250 extends from the anode, it will eventually contact the dendrite absorber material 320. Upon contact, a reaction occurs and a lithium absorber alloy 410 forms. The lithium absorber alloy forms as a result of lithium diffusion between the dendrite 250 and the dendrite absorber material 320. The growth of the dendrite 250 between the anode and the cathode will stop or significantly slow down at the dendrite absorber layer 320 when the lithium alloy forms at absorber material 320.

The dendrite absorber material may be formed from a plurality of materials. Examples of materials that can be used to implement a dendrite absorber material include silicon monoxide, zinc, silver, tin, gold, and bismuth.

The dendrite absorber material may be a thickness that is conducive to the functionality discussed herein. In some instances, a layer of the dendrite absorber material has a thickness of between 5 nanometers and 50 micrometers. In some instances, the dendrite absorber material has a thickness between 200 nanometers and 10 micrometers.

The ceramic layer, which may be implemented as a conventional ceramic or lithium ion conductor ceramic, may be implemented as one of a variety of materials, including but not limited to LATSPO, LISICON, LICGC, LAGP, LLZO, LZO, LAGTP, LiBETI, LiBOB, LiTf, LiTF, LLTO, LLZP, LTASP, LTZ, or MgO.

The solid-state electrolyte may be implemented in a variety of ways, including but not limited to LPS, LSPSC, LGPS, LBSO, LATSPO, LISICON, LICGC, LAGP, LLZO, LZO, LAGTP, LiBETI, LiBOB, LiTf, LiTF, LLTO, LLZP, LTASP, LiFSI, LiTFSI, and LTZP.

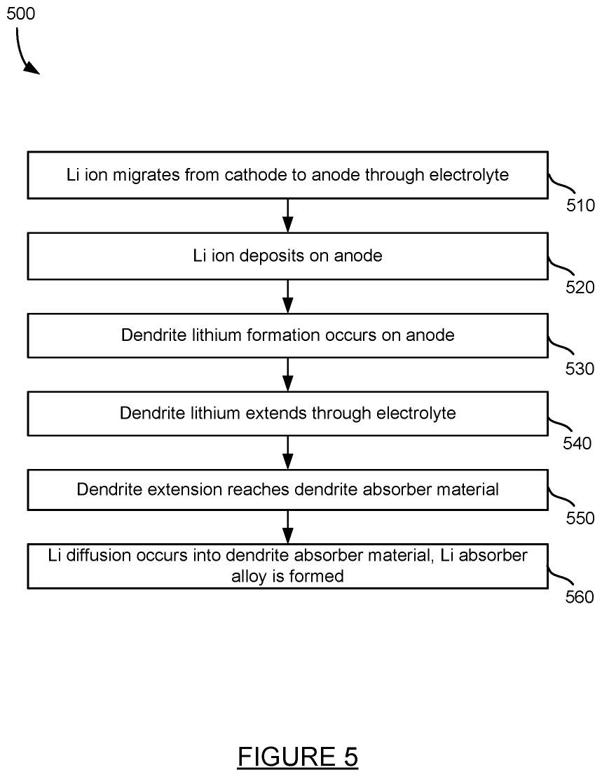

FIG. 5 is a method for limiting dendritic lithium growth using a lithium dendrite absorber. First, a lithium-ion migrates from a cathode to an anode through an electrolyte at step 510. Lithium-ions deposit on an anode at step 520. Dendrite lithium formation occurs on the anode at step 530. The dendrite lithium formation occurs over time as the battery cell goes through iterations of charge and discharge cycles. The lithium dendrite extends, over time, through the electrolyte from the anode towards the cathode at step 540. If left unmetered, the dendrite lithium would eventually extend from the anode to the cathode and form a short circuit between the anode and the cathode. Typically, this would result in a heat release, usually causing the lithium battery cell to catch fire.

The dendrite extension, and the present technology, reaches a dendrite absorber material at step 550. The dendrite extension may reach the dendrite absorber material positioned directly in front of the anode, positioned behind a ceramic isolation layer, or otherwise positioned in the path of the dendrite extension between the anode and the cathode. Lithium diffusion occurs at the dendrite absorber material when the dendrite extension reaches the dendrite absorber material. As a result of the lithium diffusion, a lithium absorber alloy is formed at the dendrite absorber material. Once the lithium absorber alloy is formed, the dendrite will not extend past the lithium absorber material, thereby greatly reducing the risk of fire due to short-circuiting between the anode and cathode due to dendrite lithium formation.

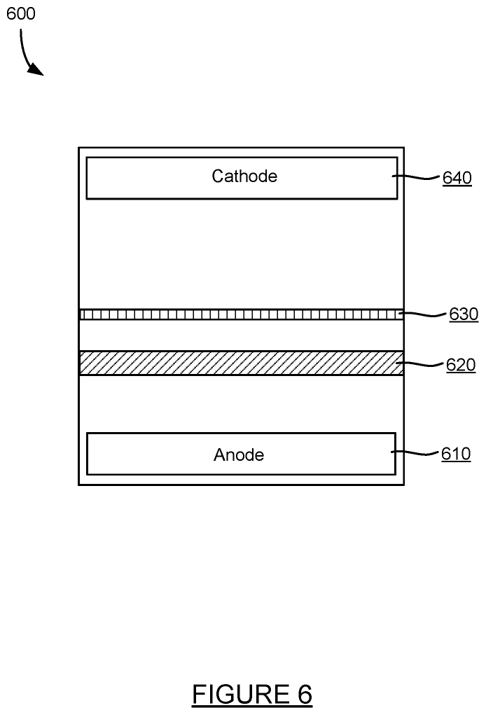

The dendrite absorber material placed between an anode and cathode a battery cell serves to curb the dendrite growth from the anode towards the cathode. In addition to a dendrite absorber material, one or more ceramic isolation layers may also be implemented between an anode and cathode. Several configurations of dendrite absorber materials and ceramic isolation layers are possible within a battery cell. Some exemplary configurations of implementing a dendrite absorption material and a ceramic isolation layer are discussed with respect to FIGS. 6-9.

FIG. 6 is a block diagram of a battery cell with a first lithium dendrite absorber and ceramic layer configuration within the battery cell. The battery cell 600 of FIG. 6 includes anode 610, cathode 640, dendrite absorber material 620, and ceramic isolation layer 630. In the configuration of cell 600, the dendrite absorption layer 620 is between anode 610 and the ceramic isolation layer 630.

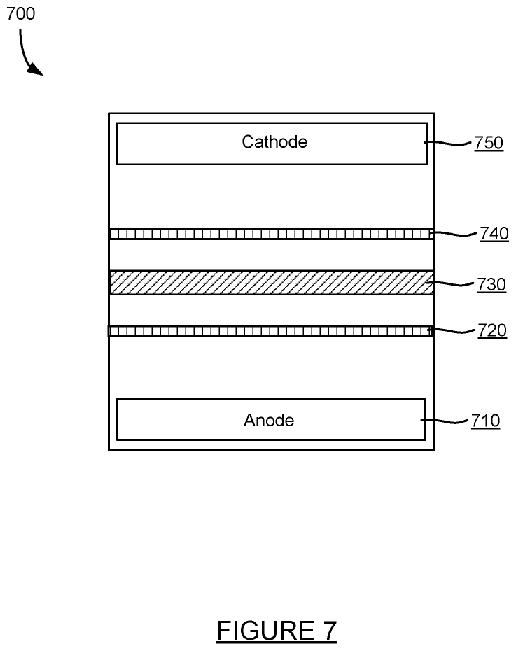

FIG. 7 is a block diagram of a battery cell with a second lithium dendrite absorber and ceramic layer configuration within the battery cell. The battery cell 700 of FIG. 7 includes anode 710, cathode 750, ceramic isolation layers the 720 and 740, and dendrite absorption layer 730. In the configuration of battery cell 700, a ceramic isolation layer is placed on either side of the dendrite absorption layer 730.

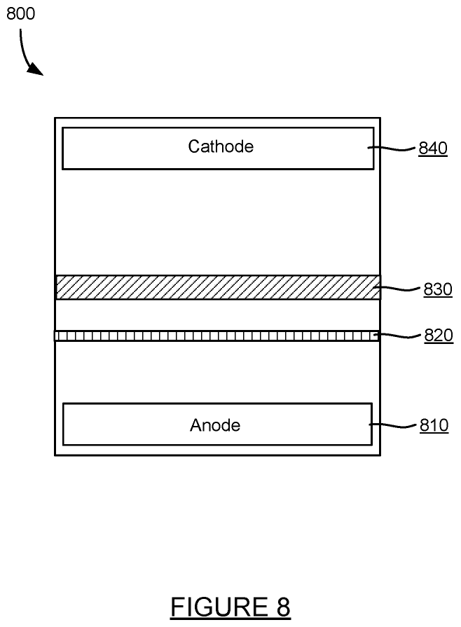

FIG. 8 is a block diagram of a battery cell with a third lithium dendrite absorber and ceramic layer configuration within the battery cell. The battery cell 800 of FIG. 8 includes anode 810, cathode 840, ceramic isolation layer 820, and dendrite absorber layer 830. In the battery cell 800, the ceramic isolation layer 820 is displaced between the dendrite absorption layer 830 and anode 810.

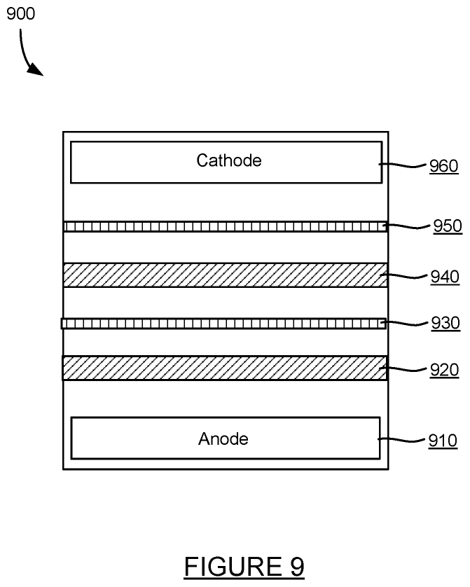

FIG. 9 is a block diagram of a battery cell with a fourth lithium dendrite absorber and ceramic layer configuration within the battery cell. In the battery cell 900 of FIG. 9, the battery cell includes anode 910, cathode 960, dendrite absorption layers 920 and 940, and ceramic isolation layers 930 and 950. In the configuration of battery cell 900 of FIG. 9, the dendrite absorption layers 920 and 940 are positioned to alternate with the ceramic isolation layers 930 and 950. In the embodiment illustrated in FIG. 9, the dendrite absorption layer 920 is directly in front of anode 910, followed by ceramic isolation layer 930, followed by dendrite absorption layer 940, and then followed by ceramic isolation layer 950. In some instances, a ceramic isolation layer may be placed in front of anode 910 and the remaining layers will alternate from the ceramic isolation layer.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A lithium ion battery cell, comprising;
a casing;
a cathode;
an anode including lithium ions;
an electrolyte between the anode and the cathode, wherein dendrite lithium material forms on the anode due at least in part to lithium ion migration from the cathode to the anode; and
a dendrite absorber material between the anode and the cathode, the dendrite absorber reacting with the dendrite lithium material that forms at the anode and extends toward the cathode, the reaction between the dendrite absorber and the dendrite lithium material reducing an extension of dendrite lithium material extending from the anode to the cathode.

2. The lithium ion battery cell of claim 1, wherein the dendrite absorber reacts with the with dendrite lithium material to form a lithium absorber alloy

3. The lithium ion battery cell of claim 2, wherein the reaction between the dendrite absorber and the dendrite lithium material curbs the growth of the dendrite lithium material towards the cathode and prevents a short circuit from forming between the anode and the cathode by dendrite lithium material.

4. The lithium ion battery cell of claim 2, wherein the reaction includes lithium diffusion

5. The lithium ion battery cell of claim 1, wherein the lithium absorber includes one or a combination of silicon monoxide, zinc, silver, tin, platinum, gold, bismuth, silicon, silicon-carbon composite, aluminum, carbon, and lithium-M alloys (M=silicon monoxide, zinc, silver, tin, platinum, gold, bismuth, silicon, silicon-carbon composite, aluminum).

6. The lithium ion battery cell of claim 1, wherein the dendrite absorber material has a thickness between 5 nanometers and 50 micrometers.

7. The lithium ion battery cell of claim 6, wherein the dendrite absorber material has a thickness between 200 nanometers and 10 micrometers.

8. The lithium ion battery cell of claim 1, wherein lithium ions pass through the dendrite absorber material between the cathode and the anode.

9. The lithium ion battery cell of claim 1, further comprising a ceramic layer between the cathode and the anode.

10. The lithium ion battery cell of claim 9, wherein the lithium ion battery cell includes a dendrite layer between two ceramic layers.

11. The lithium ion battery cell of claim 9, wherein the dendrite layer is between the anode and the ceramic layer.

12. The lithium ion battery cell of claim 9, wherein the dendrite layer is between the ceramic layer and the cathode.

13. The lithium ion battery cell of claim 9, wherein the lithium ion battery cell includes at least two ceramic layers and at least two dendrite layers that alternate between the cathode and the anode

14. The lithium ion battery cell of claim 9, wherein lithium ions pass through the ceramic layer between the cathode and the anode
